(19) United States
(12) Patent Application Publication
(10) Pub. No.: US 2026/0369645 A1
(43) Pub. Date: Nov. 19, 2026

(54) ION-CONDUCTING POLYMER, REINFORCED COMPOSITE MEMBRANE AND FUEL CELL

(71) Applicant: KOREA INSTITUTE OF SCIENCE AND TECHNOLOGY, Seoul (KR)

(72) Inventors: Jin Young Kim, Seoul (KR); Semin YANG, Seoul (KR); Hae Jung SON, Seoul (KR); Hyunjung JIN, Seoul (KR)

(21) Appl. No.: 19/646,177

(22) Filed: Apr. 13, 2026

(30) Foreign Application Priority Data
Apr. 18, 2025 (KR) 10-2025-0050963

(51) Int. Cl. H01M 8/1037; C08F 8/12; C08F 8/42; C08G 77/442; H01M 8/1004; H01M 8/1027; H01M 8/1032; H01M 8/1039; H01M 8/1058

(52) U.S. Cl. CPC H01M 8/1037; C08F 8/12; C08F 8/42; C08G 77/442; H01M 8/1004; H01M 8/1027; H01M 8/1032; H01M 8/1039; H01M 8/1058; C08F 2810/20; H01M 2300/0082; H01M 2300/0094

(57) ABSTRACT

The disclosure relates to an ion-conductive polymer, a reinforced composite membrane, and a fuel cell. More specifically, the disclosure relates to an ion-conductive polymer, which is a Nafion-based polymer having a silane pendant group, and a reinforced composite membrane and a fuel cell including the same. The reinforced composite membrane includes a support; and an electrolyte membrane including the ion-conductive polymer.

### CROSS-REFERENCE TO RELATED APPLICATION

This application claims the benefit of Korean Patent Application No. 10-2025-0050963, filed on Apr. 18, 2025, in the Korean Intellectual Property Office, the entire disclosure of which is incorporated herein by reference for all purposes.

### BACKGROUND

### 1. Field of the Invention

One or more embodiments relate to an ion-conductive polymer, and to a reinforced composite membrane and a fuel cell including the ion-conductive polymer.

### 2. Description of the Related Art

A fuel cell is an environmentally friendly energy device having high energy efficiency and has attracted attention as a next-generation power source. A polymer electrolyte membrane fuel cell (PEMFC), which is a low-temperature fuel cell, has high utility as a mobile fuel cell for automobiles and drones. PEMFC development has achieved a high level of technology in terms of low-temperature operation and energy efficiency, but improvement in cost and durability is required. Accordingly, a core material development strategy that enables long-term operation and cost reduction of PEMFC is required.

Among components of a PEMFC, a membrane-electrode assembly (MEA) is a core material that determines the performance of a fuel cell. The MEA includes a catalyst layer where an electrode reaction occurs and an electrolyte membrane.

A main cause of performance degradation exhibited by MEA materials is deterioration in physical durability due to continuous expansion and contraction in a PEMFC operating environment. In addition, performance degradation of MEA materials results from chemical damage to the materials caused by hydrogen peroxide and radical species formed inside the MEA due to side reactions in the electrode and hydrogen/oxygen gas permeation. Such chemical damage is inevitably generated during PEMFC operation.

To prevent physical and chemical damage, the MEA may include crosslinked polymers with ensured durability in the electrolyte membrane. The crosslinked polymer participates in a reaction with a sulfonic acid functional group of perfluorosulfonic acid (PFSA), which affects the electrochemical properties of the PFSA. This may induce a decrease in the initial performance of the PEMFC due to a decrease in proton conductivity of the electrolyte membrane. In addition, introducing a crosslinked polymer into a polymer electrolyte may require an additional process in an MEA manufacturing process, such as physical mixing and coating of PFSA and the crosslinked polymer.

Therefore, there is a need for the development of a polymer electrolyte membrane that facilitates a crosslinking reaction and has physical and chemical durability without significantly affecting the performance of the MEA, and a highly durable electrode utilizing the polymer electrolyte membrane.

### SUMMARY

According to an embodiment, the disclosure provides a novel ion-conductive polymer into which a silane pendant group is introduced.

According to an embodiment, the disclosure provides an electrolyte membrane that includes the novel ion-conductive polymer of the disclosure and has improved durability (e.g., mechanical durability) while maintaining ion conductivity.

According to an embodiment, the disclosure provides a reinforced composite membrane that includes the novel ion-conductive polymer of the disclosure and has improved durability (e.g., mechanical durability) while maintaining ion conductivity.

According to an embodiment, the disclosure provides a membrane-electrode assembly including the novel ion-conductive polymer of the disclosure.

According to an embodiment, the disclosure provides a fuel cell including the novel ion-conductive polymer of the disclosure.

However, technical goals to be achieved are not limited to those described above, and other goals not mentioned above can be clearly understood by one of ordinary skill in the art from the following description.

According to an embodiment, an ion-conductive polymer of the disclosure may be a Nafion-based polymer having a silane pendant group (A) represented by Formula 1:

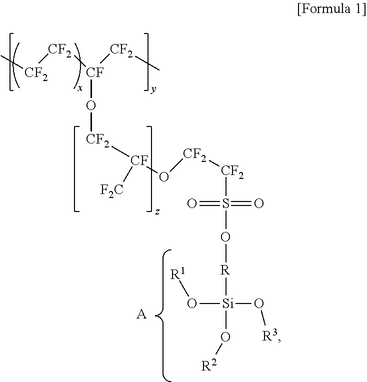

wherein, in Formula 1, R and R¹ to R³ are derived from a trialkylsilane, R is an aliphatic group having 3 to 20 carbon atoms and includes one or more oxygen atoms in a molecular structure thereof, and the alkyl has 1 to 3 carbon atoms.

According to an embodiment, a mass ratio of the silane pendant group to the Nafion-based polymer in the ion-conductive polymer may be 1:99 to 20:80 on a weight basis (w/w).

According to an embodiment, the compound represented by Formula 1 may be converted into a hydrolysis product represented by Formula 1a:

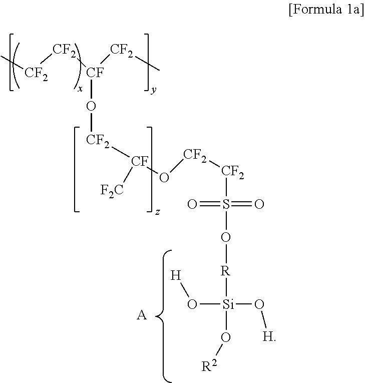

According to an embodiment, the compound represented by Formula 1 may be converted into a hydrolysis product, and then converted into a condensate represented by Formula 1b having a three-dimensional (3D) network structure formed by crosslinking:

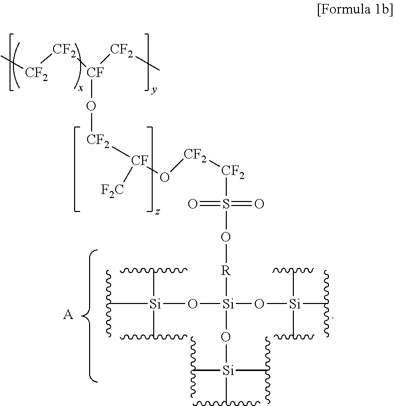

According to an embodiment, a reinforced composite membrane of the disclosure may include a support, and an electrolyte membrane including the ion-conductive polymer of the disclosure, wherein the electrolyte membrane is disposed on one surface or both surfaces of the support.

According to an embodiment, the electrolyte membrane may include a condensate formed by crosslinking of the ion-conductive polymer, and a crosslinking site may be the silane pendant group.

According to an embodiment, the support may be a perfluorinated polymer film.

According to an embodiment, a fuel cell of the disclosure may include the reinforced composite membrane of the disclosure, and an anode catalyst layer and a cathode catalyst layer respectively formed on both surfaces of the reinforced composite membrane.

Additional aspects of embodiments will be set forth in part in the description which follows and, in part, will be apparent from the description, or may be learned by practice of the disclosure.

According to embodiments, the disclosure may provide a novel ion-conductive polymer into which a silane pendant group is introduced.

The disclosure may provide a reinforced composite membrane into which the novel ion-conductive polymer of the disclosure is introduced and which has a low dimensional change rate, a low hydrogen permeability, and improved durability (e.g., mechanical durability), and a membrane-electrode assembly and a fuel cell including the reinforced composite membrane.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates, according to an embodiment, a manufacturing process of a polymer electrolyte membrane of the disclosure.

FIG. 2 illustrates, according to an embodiment, a schematic diagram of an electrolyte membrane system into which an ion-conductive polymer of the disclosure is introduced, and the schematic diagram relates to a Nafion system and a Nafion-GOPSX system including the ion-conductive polymer of the disclosure.

FIG. 3 illustrates, according to an embodiment, a configuration of a membrane-electrode assembly as an example, including a reinforced composite membrane of the disclosure.

FIG. 4 illustrates, according to an embodiment, Fourier transform infrared (FT-IR) spectra of a single-layer Nafion membrane and a single-layer Nafion-GOPSX membrane prepared in Examples.

FIG. 5 illustrates, according to an embodiment, a decrease rate of —SO₃ peak intensity according to the content of GOPS measured in FT-IR spectra of a single-layer Nafion membrane and a single-layer Nafion-GOPSX membrane prepared in Examples.

FIG. 6 illustrates, according to an embodiment, 1H NMR spectra of a single-layer Nafion membrane and a single-layer Nafion-GOPSX membrane prepared in Examples.

FIG. 7 illustrates, according to an embodiment, ion exchange capacity (IEC) of a reinforced Nafion membrane and a reinforced Nafion-GOPSX membrane prepared in

### Examples.

FIG. 8 illustrates, according to an embodiment, Si narrow-scan X-ray photoelectron spectroscopy (XPS) spectra of a reinforced Nafion membrane and a reinforced Nafion-GOPSX membrane prepared in Examples.

FIG. 9 illustrates, according to an embodiment, the proton conductivity of a reinforced Nafion membrane and a reinforced Nafion-GOPSX membrane prepared in Examples.

FIG. 10 illustrates, according to an embodiment, the thickness dimensional change rates of a reinforced Nafion membrane and a reinforced Nafion-GOPSX membrane prepared in Examples.

FIG. 11 illustrates, according to an embodiment, unit cell performance evaluation graphs (current-voltage (I-V) & power density curves) of a reinforced Nafion membrane and a reinforced Nafion-GOPSX membrane prepared in Examples.

FIG. 12 illustrates, according to an embodiment, the unit cell hydrogen permeability of a reinforced Nafion membrane and a reinforced Nafion-GOPSX membrane prepared in Examples.

FIG. 13 illustrates, according to an embodiment, wet/dry accelerated stress test (AST) open circuit voltage (OCV) results of a reinforced Nafion membrane and a reinforced Nafion-GOPS6 membrane prepared in Examples.

FIG. 14 illustrates, according to an embodiment, wet/dry AST hydrogen permeability results of a reinforced Nafion membrane and a reinforced Nafion-GOPS6 membrane prepared in Examples.

### DETAILED DESCRIPTION

Hereinafter, embodiments of the present disclosure will be described in detail with reference to the accompanying drawings. When it is determined that detailed description related to a related known function or configuration may make the purpose of the present disclosure unnecessarily ambiguous in describing the present disclosure, the detailed description will be omitted here. In addition, terminologies used herein are defined to appropriately describe the example embodiments and thus may be changed depending on a user, the intent of an operator, or a custom of a field to which the present disclosure pertains. Accordingly, the terminologies must be defined based on the following overall description of the present specification. In the drawings, like reference numerals are used for like elements.

In the whole specification, when a member is positioned “on” another member, this not only includes a case that the member is brought into contact with the other member, but also includes a case that another member exists between two members.

It will be understood that when a certain part “includes” a certain component, the part does not exclude another component but may further include another component.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and do not limit the components in other aspects (e.g., importance or order). For example, suitable results may be achieved if the described techniques are performed in a different order and/or if the described components are combined in a different manner and/or replaced or substituted by other components or their equivalents. Therefore, other implementations, other embodiments, and equivalents to the claims are also within the scope of the following claims.

Hereinafter, the ion-conductive polymer of the disclosure, use thereof, and a manufacturing method thereof will be described in detail with reference to embodiments and drawings. However, the present disclosure is not limited to the embodiments and drawings.

According to an embodiment, the ion-conductive polymer of the disclosure may be a novel ionomer, which is a Nafion-based polymer having a silane pendant group. In the ion-conductive polymer, a silane pendant group that is easy to synthesize is introduced into a Nafion-based polymer. Utilizing the ion-conductive polymer, an electrolyte membrane or a reinforced composite membrane for a fuel cell may be provided. For example, a novel ionomer into which a silane pendant group is introduced may be provided at low cost by using a process of mixing Nafion and a silane-based compound, which is a precursor of the silane pendant group, and then forming a membrane. The silane pendant group derived from the precursor is bonded to the Nafion-based polymer and may provide a crosslinking site.

According to an embodiment, the ion-conductive polymer may be a compound represented by the following Formula 1, which is a Nafion-based polymer having a silane pendant group (A).

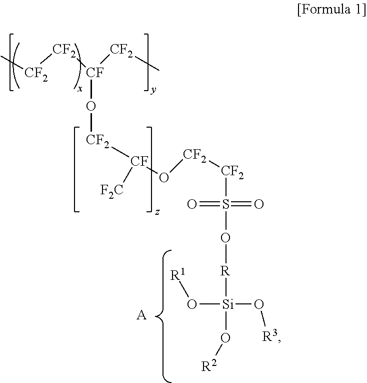

According to an embodiment, in Formula 1, R and R¹ to R³ are derived from a trialkylsilane. For example, R may be an aliphatic group having 3 to 20 carbon atoms, or an aliphatic group having 3 to 20 carbon atoms and including one or more oxygen atoms (—O—, ═O) or a hydroxyl group (—OH) in a molecular structure thereof. The aliphatic group may be a linear chain, a branched chain, or a non-aromatic ring. The alkyl may be an alkyl having 1 to 3 carbon atoms. In Formula 1, x, y, and z are related to Nafion, and x, y, and z may each be an integer of 1 or more; 10 or more; 100 or more (or less); 300 or more (or less); 500 or more (or less); 1000 or more (or less); 2000 or more (or less); or 3000 or more (or less).

According to an embodiment, the precursor of the silane pendant group may be a trialkylsilane-based compound having an aliphatic substituent or chain. For example, the precursor may include a triethoxysilane-based compound, a trimethoxysilane-based compound, or both. The trialkylsilane-based compound may include at least one selected from the group consisting of 3-(trimethoxysilyl)propyl methacrylate, trimethoxy[2-(7-oxabicyclo[4.1.0]hept-3-yl)ethyl]silane, trimethoxy[3-(methylamino)propyl]silane, trimethoxy(7-octen-1-yl)silane, trimethoxy (vinyl)silane, allyltrimethoxysilane, (3-glycidyloxypropyl)trimethoxysilane, (3-glycidyloxypropyl)triethoxysilane, 2-(3,4-epoxycyclohexyl)ethyltriethoxysilane, 2-(3,4-epoxycyclohexyl)ethyltrimethoxysilane, (3-aminopropyl)trimethoxysilane, (3-bromopropyl)trimethoxysilane, (3-chloropropyl)trimethoxysilane, and (3-iodopropyl)trimethoxysilane, or a combination thereof. Preferably, the trialkylsilane-based compound may be selected from (3-glycidyloxypropyl)trimethoxysilane, (3-5 glycidyloxypropyl)triethoxysilane, 2-(3,4-epoxycyclohexyl)ethyltriethoxysilane, and 2-(3,4-epoxycyclohexyl)ethyltrimethoxysilane. Preferably, the compound of Formula 1 may be selected from the following Formula 1-1.

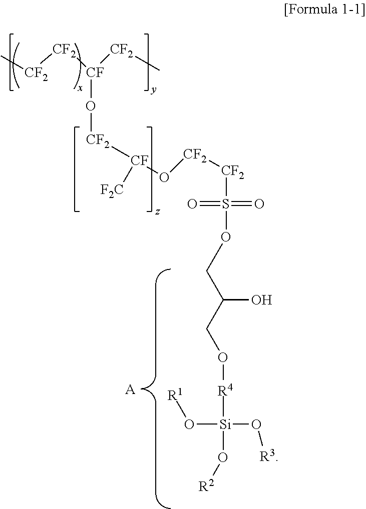

In Formula 1-1, R⁴ may be an alkylene group having 3 to 5 or 3 carbon atoms, and R¹ to R³ may each be an alkyl group having 1 to 2 carbon atoms.

According to an embodiment, the ion-conductive polymer, which is the Nafion-based polymer having the silane pendant group (A) and represented by Formula 1, may be converted into a hydrolysis product through a crosslinking process. That is, in the compound represented by Formula 1, the silane pendant group may be converted as shown in the following Formula 1a by a heating and/or drying process.

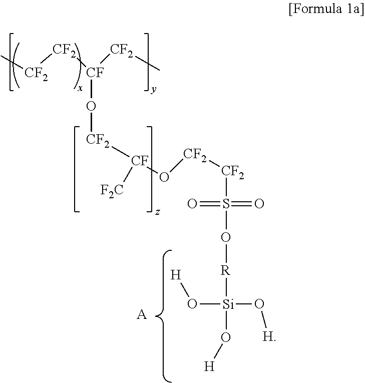

According to an embodiment, the compound represented by Formula 1 may form a condensate having a three-dimensional (3D) network structure after being converted into a hydrolysis product (i.e., the compound represented by Formula 1a). That is, in the compound represented by Formula 1, the silane pendant group is introduced into Nafion through a crosslinking reaction during a heating process and/or a drying process by heating. The compound may then be converted into a condensate having a 3D network structure of the following Formula 1b through hydrolysis and condensation. In the crosslinking process, a crosslinking site may be the silane pendant group.

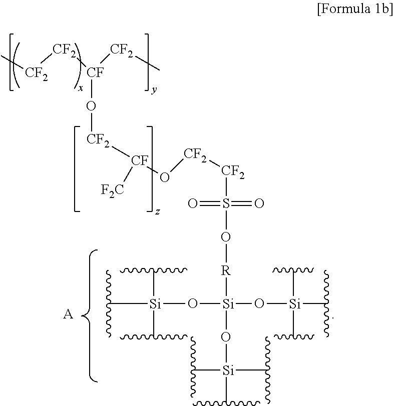

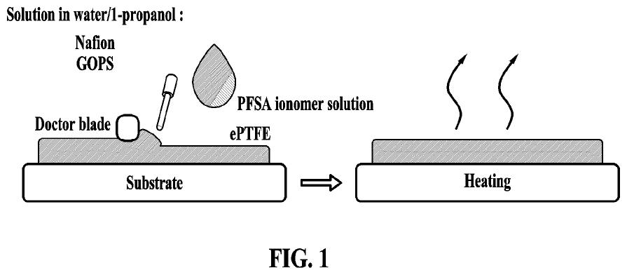

According to an embodiment, the disclosure may provide an electrolyte or an electrolyte membrane manufactured from the ion-conductive polymer of the disclosure. Referring to FIG. 1, an electrolyte or an electrolyte membrane may be formed through a crosslinking reaction by preparing a dispersion by dispersing a Nafion-based polymer and a precursor of a silane pendant group in a solvent, drying the dispersion, and heat-treating the dispersion. The drying may be performed at a temperature of 80 °C to 100 °C; 80 °C to 95 °C; or 85 °C to 95 °C for 1 minute or more; 5 minutes or more; 10 minutes or more; 5 minutes to 15 minutes; or 8 minutes to 10 minutes. The heat treatment may be performed at a temperature of 80 °C to 200 °C; 100 °C to 190 °C; 150 °C to 185 °C; or 170 °C to 180 °C for 1 minute or more; 5 minutes or more; 10 minutes or more; 20 minutes or more; or 15 minutes to 20 minutes. The dispersion may be converted into a compound represented by Formula 1, Formula 1a, or Formula 1b described above to form a liquid or solid electrolyte.

According to an embodiment, the disclosure may provide a reinforced composite membrane including an electrolyte membrane manufactured from the ion-conductive polymer of the disclosure. The reinforced composite membrane includes a support, and an electrolyte membrane disposed on one surface or both surfaces of the support. The electrolyte membrane may be impregnated to an entire depth or a partial depth (e.g., less than 100%; 90% or less; or 80% or less of the depth) of the support. The support may be applied without limitation as long as the support is a membrane applicable to a reinforced composite membrane for a fuel cell, and for example, the support may be a perfluorinated polymer film. The reinforced composite membrane may be formed by a single process in which synthesis of the ion-conductive polymer of the disclosure and membrane formation are performed simultaneously. For example, a Nafion-based polymer and a precursor of a silane pendant group may be stirred in a solvent to prepare a coating solution in which the Nafion-based polymer and the precursor are dispersed. The coating solution may then be applied onto a support (one surface or both surfaces). Heat may then be applied to finally form an electrolyte membrane including the compound of Formula 1b having a 3D network structure through crosslinking, hydrolysis, and condensation. The heat may be applied to perform heat treatment at a temperature of 80 °C to 200 °C. The heat treatment may be performed at a temperature of 80 °C to 200 °C; 100 °C to 190 °C; 150 °C to 185 °C; or 170 °C to 180 °C for 1 minute or more; 5 minutes or more; 10 minutes or more; 20 minutes or more; or 15 minutes to 20 minutes. According to an embodiment, referring to FIG. 1, FIG. 1 shows a membrane formation process of a polymer electrolyte membrane (i.e., a reinforced composite membrane) according to embodiments of the disclosure. In the membrane formation process, a dispersion is prepared by dispersing a Nafion-based polymer and a precursor of a silane pendant group in a solvent. The dispersion is then applied onto a substrate to form a first precursor membrane. A support is then positioned on the first precursor membrane. A second precursor membrane is then applied on a surface of the support opposite to the surface of the support in contact with the first precursor membrane. Drying and/or heat is then applied to provide a reinforced composite membrane manufactured from an ion-conductive polymer. In the membrane formation process, an ion-conductive polymer (e.g., Formula 1b) having a silane pendant group with a 3D crosslinked network, which is a condensate, may be synthesized on a support via the compound of Formula 1 by a crosslinking process. That is, the disclosure may provide a novel ion-conductive polymer (i.e., a condensate) into which a silane pendant group is introduced and a reinforced composite membrane at low cost.

According to an embodiment, the disclosure may simultaneously perform synthesis of an ion-conductive polymer and membrane formation (e.g., an electrolyte membrane or a reinforced composite membrane) without including an initiator (i.e., in an initiator-free environment). The disclosure may not include or may reduce an additional crosslinking process and time for membrane formation. The disclosure also may provide a reinforced composite membrane and a membrane-electrode assembly with improved reproducibility and compatibility by utilizing a crosslinking reaction using a single material (i.e., a sulfonic acid group of Nafion and a silane pendant group).

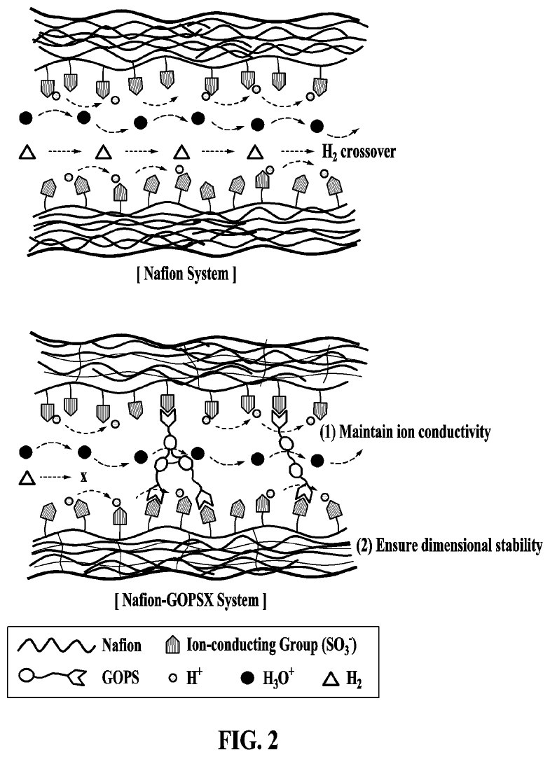

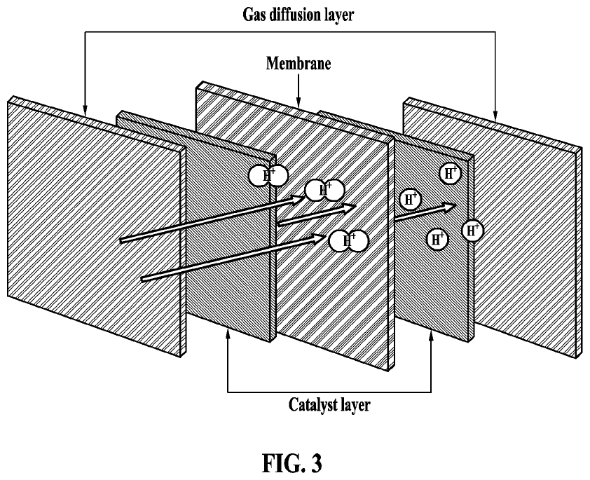

According to an embodiment, the disclosure may provide an electrolyte membrane, a reinforced composite membrane, or a membrane-electrode assembly for a fuel cell that exhibits low fuel permeability, has excellent mechanical durability, and has price competitiveness. The disclosure may synthesize a polymer composite electrolyte by inducing crosslinking within a reinforced composite membrane in a state in which existing ionomer functional groups are less affected. The disclosure may provide a polymer composite electrolyte membrane in which toughness between polymer chains is maintained without significant influence in a dynamic environment induced under various operating conditions of a hydrogen fuel cell. Furthermore, referring to FIG. 2, a polymer electrolyte membrane into which an ion-conductive polymer of the disclosure is introduced may improve mechanical durability by improving dimensional stability while maintaining proton conductivity.

According to an embodiment, the disclosure may provide a fuel cell including the novel ion-conductive polymer of the disclosure. The ion-conductive polymer may be configured in the fuel cell as an electrolyte, an electrolyte membrane, or a reinforced composite membrane. For example, the fuel cell may be a polymer electrolyte membrane fuel cell (PEMFC). FIG. 3 illustrates, according to an embodiment, a configuration of a membrane-electrode assembly as an example, including a reinforced composite membrane including a novel ionomer into which a silane pendant group is introduced. The fuel cell may include a reinforced composite membrane and a membrane-electrode assembly in which an anode layer and a cathode layer are respectively formed on both surfaces of the reinforced composite membrane. In addition, a gas diffusion layer may be introduced into each of the cathode layer and the anode layer. The anode layer and the cathode layer may include a catalyst layer or an electrode active material commonly applied to a fuel cell, and details thereof are not specifically described in this document. In addition, elements and components for fuel cell operation may be those known in the technical field of the disclosure, and details thereof are not specifically described in this document.

### Example

The following Scheme 1 illustrates a synthesis mechanism of Nafion-GOPSX into which a silane pendant group is introduced.

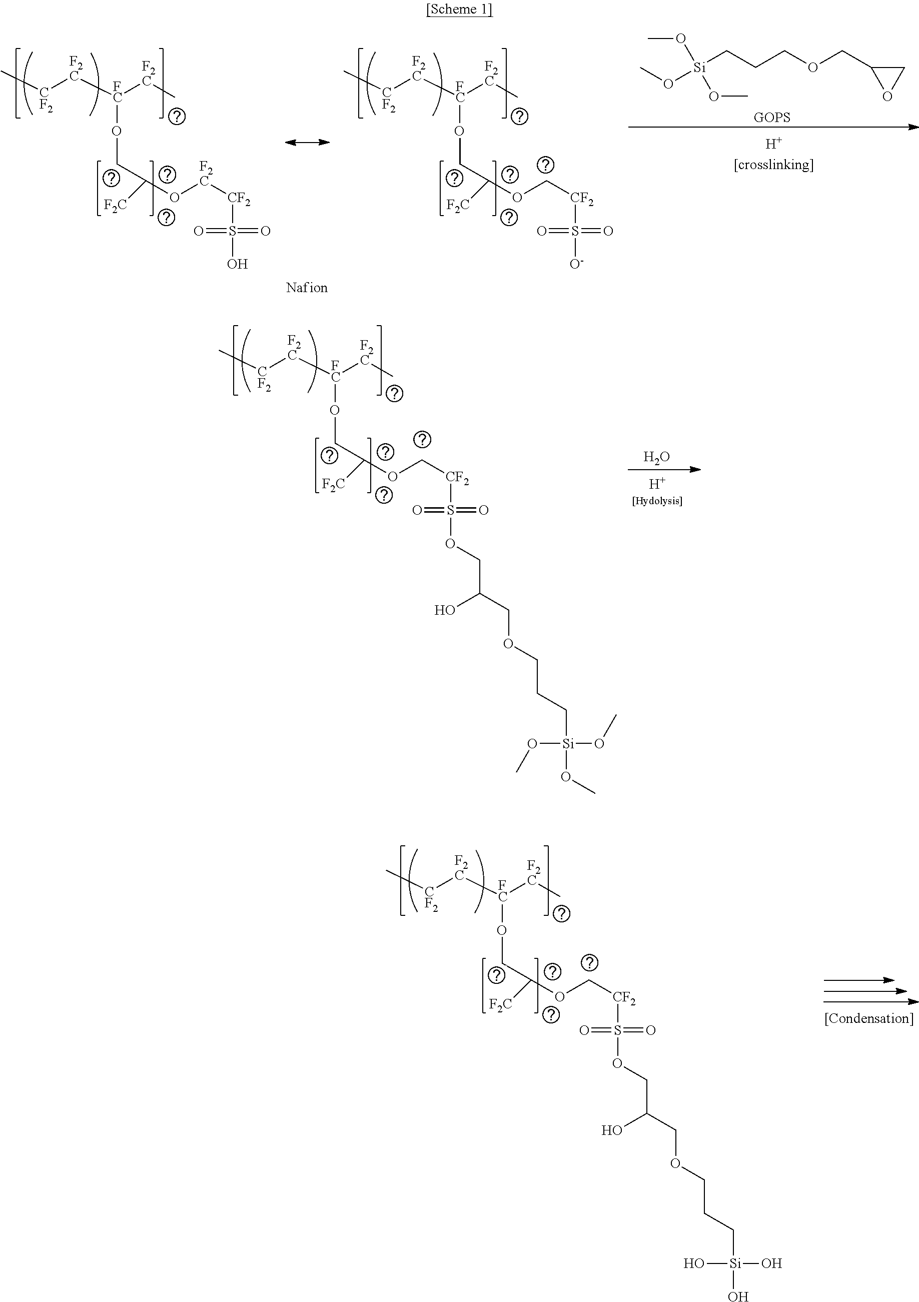

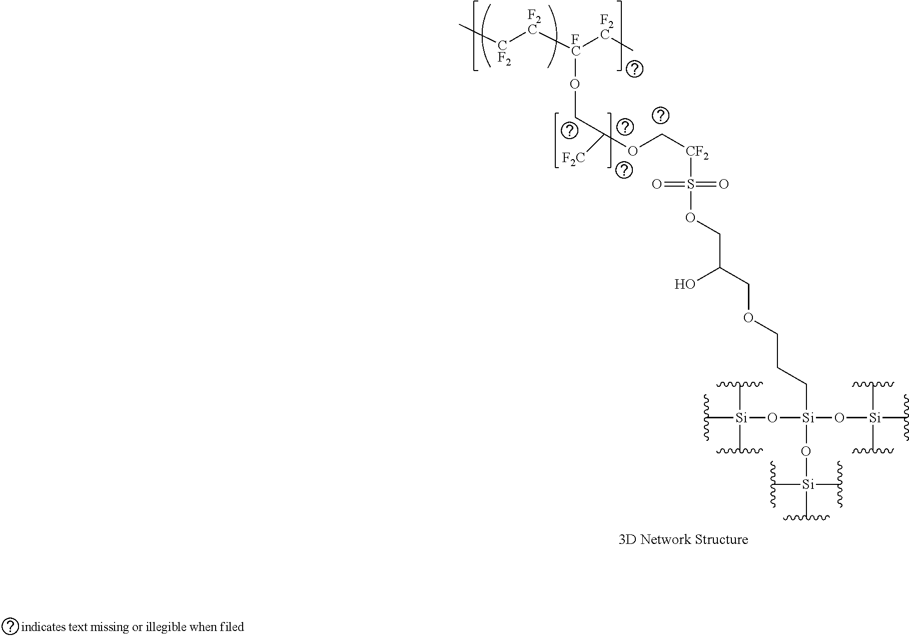

Nafion-GOPSX, which is a Nafion-based ionomer 3D network polymer material into which a silane pendant group was introduced, was synthesized according to the above synthesis mechanism. A silane pendant group was introduced through single-step synthesis by polymerization through crosslinking with existing Nafion (DuPont). GOPS ((3-glycidyloxypropyl)trimethoxysilane) was added to a Nafion ionomer at X wt % (X=3, 6, or 12) (i.e., the ratio of the introduced silane group) and dispersed to prepare a dispersion (the solvent was water and 1-propanol).

The following membranes were prepared with reference to a manufacturing process of a polymer electrolyte membrane, according to embodiments of the disclosure, shown in FIG. 1.

### Preparation of Single-Layer Nafion-GOPSX Membrane

The dispersion was spread on a doctor blade, dried at about 90 °C for 10 minutes, and then heat-treated at about 180 °C for 20 minutes to form a thin membrane. A polymer electrolyte membrane (a single-layer Nafion-GOPSX membrane) to be used in a fuel cell was formed.

### Preparation of Reinforced Nafion-GOPSX Membrane

The dispersion was spread on a doctor blade, dried at about 90 °C for 10 minutes, and then heat-treated at about 180 °C for 20 minutes to form a thin membrane. A polytetrafluoroethylene (PTFE) sheet (a support) was inserted to form a polymer electrolyte membrane (a reinforced Nafion-GOPSX membrane) to be used in a fuel cell.

### Preparation of Reinforced Nafion Membrane

A process was performed in the same manner as in the reinforced membrane Nafion-GOPSX, except that a membrane was manufactured using only the Nafion ionomer without the addition of (3-glycidyloxypropyl)trimethoxysilane (GOPS).

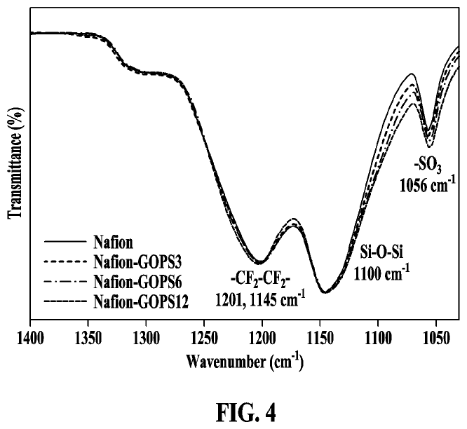

FIG. 4 illustrates, according to an embodiment, Fourier transform infrared (FT-IR) spectra of a single-layer Nafion membrane and a single-layer Nafion-GOPSX membrane prepared in Examples. Here, the single-layer Nafion-GOPSX membrane is a membrane without a PTFE support, and the reinforced Nafion-GOPSX membrane is a membrane with a PTFE support.

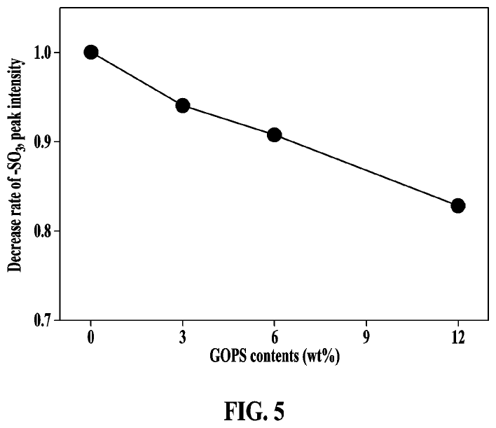

FIG. 5 illustrates, according to an embodiment, a decrease rate of —SO₃ peak intensity according to the content of GOPS measured in FT-IR spectra of the single-layer Nafion membrane and the single-layer Nafion-GOPSX membrane prepared in Examples.

Referring to FIGS. 4 and 5, the FT-IR spectra of the single-layer Nafion membrane and the single-layer Nafion-GOPSX membrane may be confirmed. A peak corresponding to a silane group was detected, and a decrease in the peak area of a sulfonic acid group of Nafion was shown. These results indicate that the silane pendant group was well formed in Nafion.

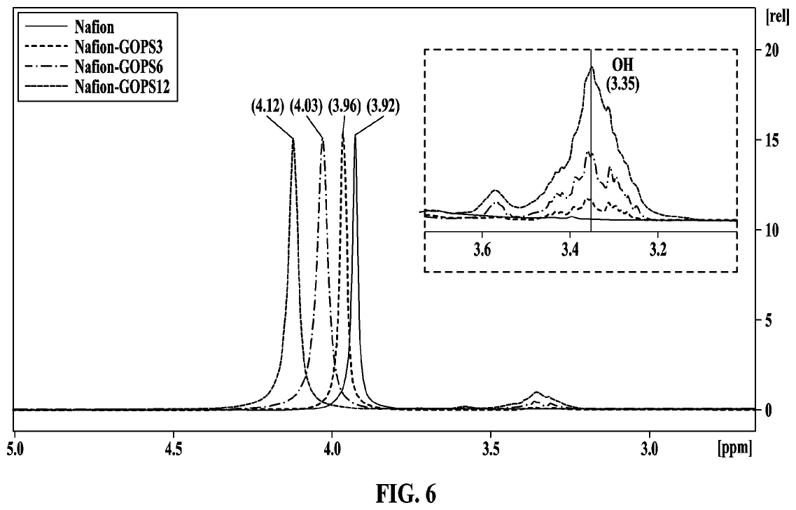

FIG. 6 illustrates, according to an embodiment, ¹H NMR spectra of the single-layer Nafion membrane and the single-layer Nafion-GOPSX membrane prepared in Examples. In FIG. 6, ¹H NMR (nuclear magnetic resonance spectroscopy) of the single-layer Nafion membrane and the single-layer Nafion-GOPSX membrane was confirmed. A peak of an OH group generated when the silane pendant group is crosslinked to Nafion shows a tendency to increase according to the content of GOPSX (X=3, 6, or 12). These results indicate that the silane pendant group was well formed in Nafion.

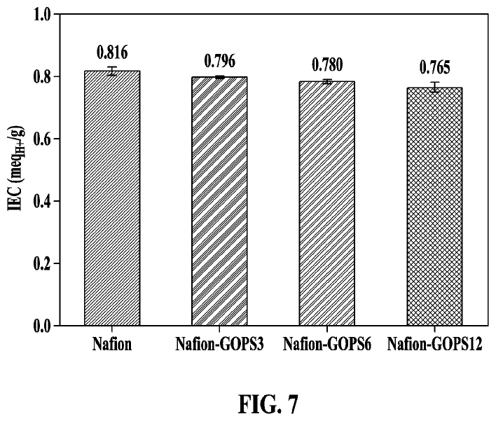

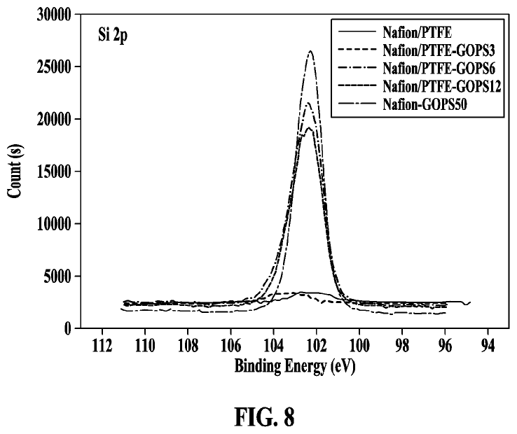

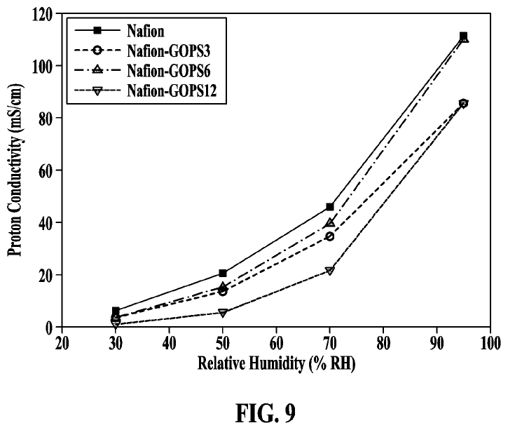

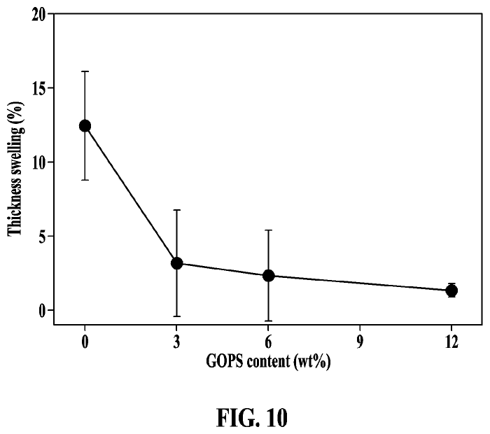

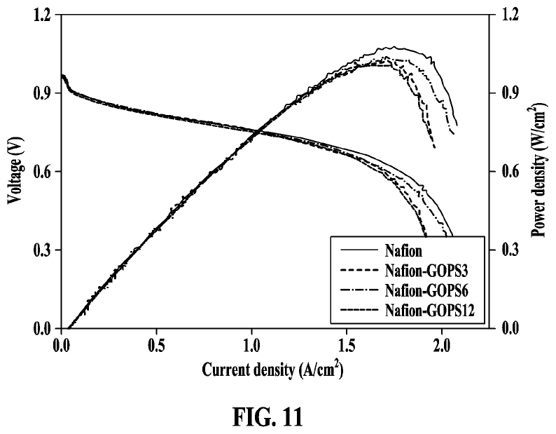

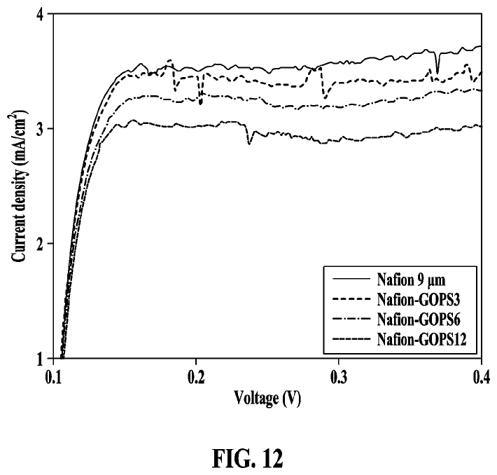

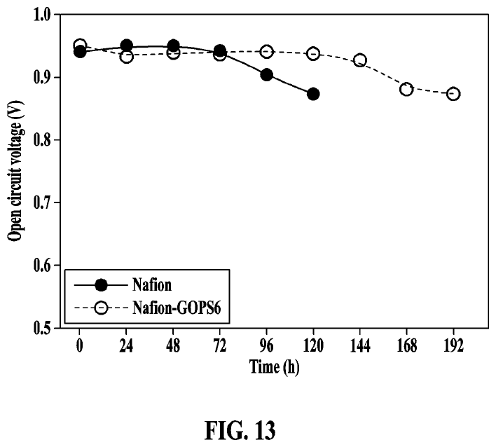

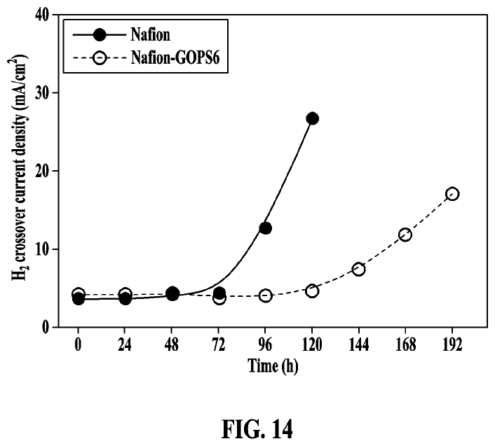

FIG. 7 illustrates, according to an embodiment, ion exchange capacity (IEC) of a reinforced Nafion membrane and a reinforced Nafion-GOPSX membrane prepared in Examples.

In FIG. 7, a decrease in a sulfonic acid group, which is an IEC site, was confirmed in the IEC of the reinforced Nafion-GOPSX membrane. This result indicates that the silane pendant group was well formed in Nafion.

FIG. 8 illustrates, according to an embodiment, Si narrow-scan X-ray photoelectron spectroscopy (XPS) spectra of the reinforced Nafion membrane and the reinforced Nafion-GOPSX membrane prepared in Examples.

In FIG. 8, XPS was analyzed for surface analysis of thin films to which the reinforced Nafion membrane and the reinforced Nafion-GOPSX membrane (X=3, 6, or 12) were added. It can be confirmed that intensity of a peak increased when the content of the silane group increased. These results indicate that the silane pendant group was well introduced into Nafion according to the ratio.

### Physical Property Evaluation

### (1) Evaluation of Proton Conductivity Maintenance

FIG. 9 illustrates, according to an embodiment, proton conductivity of the reinforced Nafion membrane and the reinforced Nafion-GOPSX membrane prepared in Examples.

That is, for the evaluation of proton conductivity maintenance, proton conductivity of the reinforced Nafion membrane and the reinforced Nafion-GOPSX membrane into which GOPSX was introduced was measured at 80 °C according to humidity. Although a sulfonic acid group, which is a conductive part, participated in crosslinking, in the case of the reinforced Nafion-GOPS6 membrane, conductivity was recovered from 70% RH. That is, the reinforced Nafion-GOPSX membrane provides a membrane having excellent mechanical strength without a decrease in conductivity compared to other crosslinking studies.

### (2) Evaluation of Dimensional Stability

FIG. 10 illustrates, according to an embodiment, the thickness dimensional change rates of the reinforced Nafion membrane and the reinforced Nafion-GOPSX membrane prepared in Examples.

For the reinforced membrane Nafion and the reinforced membrane Nafion-GOPSX, into which GOPSX was introduced, a thickness change rate was measured after impregnation in deionized water for 24 hours. It can be confirmed that the dimensional change rate decreased as GOPSX (X=3, 6, or 12) increased. These results indicate that GOPSX reduces a thickness dimensional change ratio of Nafion and provides a membrane having improved dimensional stability.

### (3) Evaluation of Unit Cell Performance Maintenance and Hydrogen Permeability

FIG. 11 illustrates, according to an embodiment, unit cell performance evaluation graphs (current-voltage (I-V) and power density curves) of the reinforced Nafion membrane and the reinforced Nafion-GOPSX membrane prepared in Examples.

FIG. 12 illustrates unit cell hydrogen permeability of the reinforced Nafion membrane and the reinforced Nafion-GOPSX membrane.

After GOPSX was added to a Nafion ionomer and stirred for 24 hours, a reinforced composite membrane having a thickness of 9 μm to 10 μm was prepared. After fastening with a unit cell, electrochemical properties were evaluated.

Referring to FIGS. 11 and 12, the hydrogen permeability of the reinforced Nafion-GOPS6 membrane was measured as 3.18 mA/cm². This shows a result of a 10.92% decrease compared to 3.57 mA/cm² when only the reinforced Nafion membrane was used.

When comparing maximum power density, the reinforced Nafion membrane shows 1.085 W/cm², and the reinforced Nafion-GOPS6 membrane shows 1.044 W/cm², showing a performance level similar to the reinforced Nafion membrane. These results indicate that the unit cell performance of the reinforced Nafion-GOPS6 membrane was maintained, and the hydrogen permeability was decreased by 10.92%, thereby providing the preparation of an excellent electrolyte membrane.

### (4) Evaluation of Durability (Unit Cell Performance and Hydrogen Permeability)

FIG. 13 illustrates, according to an embodiment, wet/dry accelerated stress test (AST) open circuit voltage (OCV) results of the reinforced Nafion membrane and the reinforced Nafion-GOPS6 membrane prepared in Examples.

FIG. 14 illustrates, according to an embodiment, wet/dry AST hydrogen permeability results of the reinforced Nafion membrane and the reinforced Nafion-GOPS6 membrane prepared in Examples.

Wet/dry AST was performed on the reinforced Nafion membrane and the reinforced Nafion-GOPS6 membrane. By adding the reinforced Nafion-GOPS6 membrane, the hydrogen permeability of the membrane was measured as 16.99 mA/cm² after 8 days. In FIGS. 13 and 14, it can be confirmed that a lifespan was extended by 3 days compared to 26.65 mA/cm² after 5 days when only the reinforced Nafion membrane was used. Therefore, the novel ionomer polymer into which the silane pendant group of the disclosure is introduced and the reinforced membrane or the reinforced composite membrane utilizing the same provide an improved durability effect.

The disclosure provides a novel ionomer polymer into which a silane pendant group is introduced. Using the novel ionomer polymer, the disclosure provides a reinforced composite membrane for a fuel cell, a membrane-electrode assembly, and a fuel cell with excellent performance and improved mechanical durability. That is, the polymer electrolyte membrane made of the novel ionomer polymer of the disclosure provides equivalent or improved performance when compared in performance with a commercial polymer electrolyte membrane. In addition, the measured mechanical durability results indicate significantly improved durability characteristics in lifespan compared to commercially available materials. Referring to FIG. 2, the reinforced composite membrane into which Nafion-GOPSX is introduced improves mechanical durability, including dimensional stability, while maintaining proton conductivity similar to that of the reinforced composite membrane of existing Nafion. Furthermore, the Nafion-GOPSX polymer electrolyte membrane (i.e., the reinforced membrane) formed by adding GOPSX has reduced hydrogen permeability compared to the existing reinforced Nafion membrane. In addition, the Nafion-GOPSX polymer electrolyte membrane formed by adding GOPSX has a reduced dimensional change rate compared to the existing Nafion membrane. In addition, the Nafion-GOPSX polymer electrolyte membrane formed by adding GOPSX improves durability compared to the existing Nafion membrane.

A number of embodiments have been described above. Nevertheless, it should be understood that various modifications may be made to these embodiments. For example, suitable results may be achieved if the described techniques are performed in a different order and/or if the described components are combined in a different manner and/or replaced or substituted by other components or their equivalents. Therefore, other implementations, other embodiments, and equivalents to the claims are also within the scope of the following claims.

What is claimed is:

1. An ion-conductive polymer, which is a Nafion-based polymer having a silane pendant group (A) represented by Formula 1: 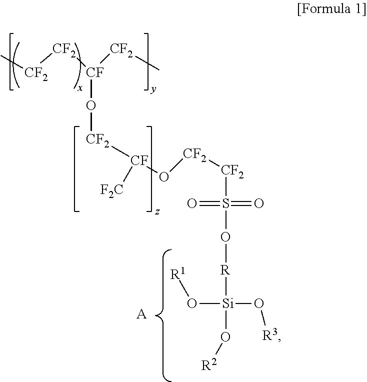
wherein, in Formula 1, R and R¹ to R³ are derived from a trialkylsilane, R is an aliphatic group having 3 to 20 carbon atoms and includes one or more oxygen atoms in a molecular structure thereof, and the alkyl has 1 to 3 carbon atoms.

2. The ion-conductive polymer of claim 1, wherein the trialkylsilane is a trimethoxysilane or a triethoxysilane, and
the trialkylsilane comprises at least one selected from the group consisting of 3-(trimethoxysilyl)propyl methacrylate, trimethoxy[2-(7-oxabicyclo[4.1.0]hept-3-yl)ethyl]silane, trimethoxy[3-(methylamino)propyl]silane, trimethoxy(7-octen-1-yl)silane, trimethoxy(vinyl)silane, allyltrimethoxysilane, (3-glycidyloxypropyl)trimethoxysilane, (3-glycidyloxypropyl)triethoxysilane, 2-(3,4-epoxycyclohexyl)ethyltriethoxysilane, and 2-(3,4-epoxycyclohexyl)ethyltrimethoxysilane.

3. The ion-conductive polymer of claim 1, wherein the compound of Formula 1 is selected from Formula 1-1: 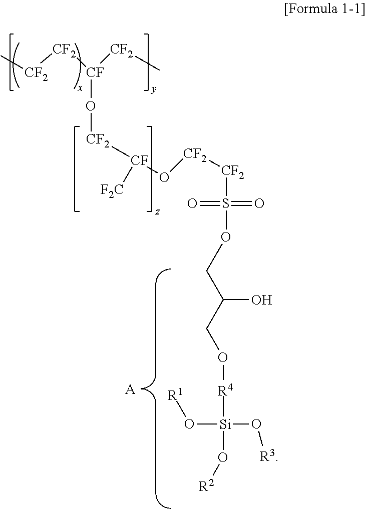
wherein, in Formula 1-1, R⁴ is an alkylene group having 3 to 5 carbon atoms, and R¹ to R³ are each an alkyl group having 1 to 3 carbon atoms.

4. The ion-conductive polymer of claim 3, wherein, in Formula 1-1, R⁴ is an alkylene group having 3 carbon atoms, and R¹ to R³ are each an alkyl group having 1 to 2 carbon atoms.

5. The ion-conductive polymer of claim 1, wherein a mass ratio of the silane pendant group to the Nafion-based polymer in the ion-conductive polymer is 1:99 to 20:80 on a weight basis (w/w).

6. The ion-conductive polymer of claim 1, wherein the compound represented by Formula 1 is converted into a hydrolysis product represented by Formula 1a:

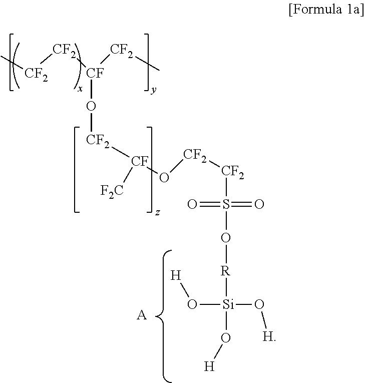

7. The ion-conductive polymer of claim 1, wherein the compound represented by Formula 1 is converted into a hydrolysis product, and is then converted into a condensate represented by Formula 1b having a three-dimensional (3D) network structure formed by crosslinking:

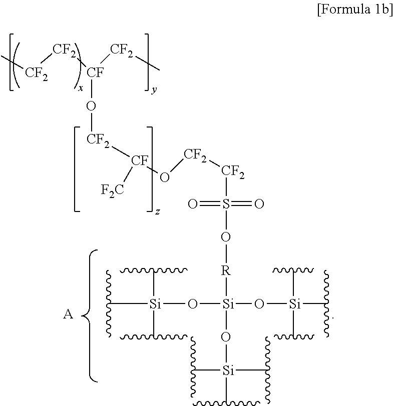

8. A reinforced composite membrane comprising:
a support; and
an electrolyte membrane comprising the ion-conductive polymer of claim 1, wherein the electrolyte membrane is disposed on one surface or both surfaces of the support.

9. The reinforced composite membrane of claim 8, wherein the electrolyte membrane comprises a condensate formed by crosslinking of the ion-conductive polymer, and a crosslinking site is the silane pendant group.

10. The reinforced composite membrane of claim 8, wherein the support is a perfluorinated polymer film.

11. A fuel cell comprising:
a membrane-electrode assembly comprising:
the reinforced composite membrane of claim 8; and
an anode catalyst layer and a cathode catalyst layer respectively formed on both surfaces of the reinforced composite membrane.
